(19) United States
(12) Patent Application Publication
(10) Pub. No.: US 2009/0094167 A1
(43) Pub. Date: Apr. 9, 2009

(54) ELECTRONIC BIDDING METHOD FOR MAXIMIZING THE RATE OF RETURN FOR FUNDS IN EXCESS OF CURRENT REQUIREMENTS

(76) Inventors: Phillip D. Murphy, Charlotte, NC (US); Christopher Winters, Pacific Palisades, CA (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 11/868,147

(22) Filed: Oct. 5, 2007

(51) Int. Cl. G06Q 40/00; G06F 17/30; G06F 17/40

(52) U.S. Cl. 705/36 R; 705/37

(57) ABSTRACT

An electronic method for obtaining bids for investments in guaranteed investment contracts (and similar investment products) and investments purchased for a yield restricted defeasance escrow, includes the steps of providing an investor intermediary computer having a digital data store, inputting data into the digital data store representing the bid specifications of the investment, and providing a digital input/output electronic two-way communications link allowing communication between the investor intermediary computer and a plurality of investment provider computers by means of an electronic two-way communications link. The bid specifications for the investment are transmitted to the plurality of investment provider computers, and the bids for investments received from the investment providers to make a yield-based or fixed price-based investment based on the bid specifications provided for the investment are transmitted from investment provider computers to an investor intermediary computer having a digital data store, by means of an electronic two-way communications link.

### TECHNICAL FIELD AND BACKGROUND OF THE INVENTION

This invention relates to an electronic bidding method for maximizing the rate of return for certain structured investment vehicles providing for accurate and timely delivery of bidding specifications and receipt of bids for investments in compliance with any applicable requirements or laws governing competitive procurement and bidding practices. Investors often have cash that is excess of current requirements. For example, municipalities, not-for-profit corporations, for-profit-corporations and other tax-exempt and taxable borrowers may receive funds either as a result of a bond issue, loan or other source, the proceeds of which are intended to be spent over a period of time, or from ongoing revenues, assessments, or tax collections which will become available for investment at some point in the future. For example, spending may take years during the construction of a highway, water system, school, hospital and the like. In addition, funds may be received from ongoing revenues and become available for investment periodically as those revenues are received. Often, given the uncertainty surrounding the actual date that funds may need to be expended these funds are invested in short-term, relatively low yielding investments when not in use. At present this is most often done simply by contracting with a broker or using an established relationship with a bank or trust company to invest the funds in short-term, liquid investments until needed. In such cases, there is no assurance that the highest available rate of return is being obtained on these funds and there is no ability to lock-in or determine the investment yield in advance on these excess funds.

Investment Agreements, also referred to as Guaranteed Investment Contracts (“GICs”), are ideal for the investment of these types of funds and may be used for investing the funds in excess of current requirements resulting from either tax-exempt and taxable borrowings including project, acquisition, improvement and construction funds, capitalized interest funds, debt service reserve funds and debt service, revenue or bond funds. Guaranteed Investment Contract and nonpurpose investment shall have the meaning assigned to them in CFR Title 26 Part 1 §1.148: I.R.C. §Treas. Re. §§1.148-0 et seq. A GIC pays either a fixed rate of interest or a floating rate of interest based on a predetermined floating rate index based on the needs of the investor seeking to invest funds in excess of current requirements. The bid specifications provided for the investment detail the type of yield to be paid by the investment provider to the investor for the GIC. The GIC provides a known, locked in yield for the investment while permitting the investor to withdraw the invested funds on an “as needed” basis without cost or penalty, for any purpose for which the funds were originally intended. A GIC includes any non-purpose investment that has specifically negotiated withdrawal or reinvestment provisions, a specifically negotiated interest rate, or any agreement to supply investments on two or more future dates, such as a forward supply contract forward-float agreement, forward-float investment agreement, float agreement, forward float agreement or similar investment vehicle or agreement.

GIC's are typically issued by banks, insurance companies and other financial institutions.

Since funds can often be withdrawn without cost or penalty, on an “as needed” basis, the GIC investor is not exposed to any market risk. That is, the investor is not subject to the risk of liquidating securities at a loss in the event that funds are needed sooner than anticipated in a higher interest rate environment. Also, since the GIC establishes a known, locked-in fixed or floating interest rate on all unspent funds, the investor is not exposed to reinvestment risk as all funds continue to earn the yield established by the GIC until spent. Reinvestment risk can occur in any interest rate environment, even one that is generally thought of as a “high” interest rate environment since the term of any funds reinvested in this scenario may be quite short. The use of a GIC eliminates these risks.

The GIC combines the known yield of a traditional long-term investment with the liquidity of a short-term investment. The advantages of GIC's include a guaranteed investment yield, determined in advance, with the ability to withdraw the funds on an “as needed” basis without cost or penalty for any permitted purpose. The GIC investor has protection in the event that the GIC provider is downgraded through downgrade provisions outlined in the bid specifications provided for the investment and supporting GIC documentation. Moreover, the GIC eliminates market risk and reinvestment risk.

Investments purchased for a yield restricted defeasance escrow typically include fixed rate securities and may or may not include an agreement to supply investments on two or more future dates, such as a forward supply contract, forward-float agreement, forward-float investment agreement, float agreement, forward float agreement or similar investment vehicle or agreement. As used herein the term “Investments purchased for a yield restricted defeasance escrow” and “defeasance escrow” shall have the meaning assigned to it by the Internal Revenue Service of the United States of America.

### SUMMARY OF THE INVENTION

Therefore, it is an object of the invention to provide an electronic bidding system and method for maximizing the rate of return for funds in excess of current requirements.

It is another object to provide an electronic bidding system for allowing an investor to invest funds that includes a guaranteed fixed yield, or spread versus an index rate, determined in advance.

It is another object to provide an electronic bidding system for allowing an investor the ability to withdraw the funds without cost or penalty.

It is another object to provide and electronic bidding system that provides for the timely distribution of bidding specifications to invited bidders.

It is another object to provide and electronic bidding system that in at least one embodiment prohibits bidders from changing their bids and prevents late bids.

It is another object to provide and electronic bidding system that can be customized to provide a bid process in compliance with any applicable competitive procurement and bidding requirements or laws.

It is another object to provide and electronic bidding system to allow certain permitted viewers in remote locations to observe the bids as they are submitted.

These and other objects and advantages are achieved by providing an electronic method for maximizing the rate of return for funds in excess to current requirements, comprising the steps of providing an investor intermediary computer having a digital data store, inputting data into the digital data store representing the bid specifications provided for the investment of funds excess to current requirements, providing a digital input/output electronic two-way communications link allowing communication between the investor intermediary computer and a plurality of investment provider computers by means of a web browser or other electronic two-way communications link, and transmitting the bid specifications provided for the investment for the investment of funds to the plurality of investment provider computers. Bids are received and transmitted from respective investment provider computers representing bids to make a yield-based payment for the use of the funds. The highest yielding bid for the investment that is in compliance with the bid specifications of the investment being sought received from the investment provider computers is determined, and the highest yielding bid for the investment that is in compliance with the bid specifications of the investment being sought received is accepted.

According to one embodiment of the invention, the step of receiving bids transmitted from respective investment provider computers includes the step of blocking subsequent bids in response to the same investment from the same investment provider computer.

According to another embodiment of the invention the method includes the step of preventing bidders from seeing the bid of any other bidder.

According to yet another embodiment of the invention, the method includes the step of preventing bidders from changing a bid once the bid is transmitted from the respective investment provider computer.

According to yet another embodiment of the invention, an electronic method for maximizing the rate of return for funds in excess to current requirements is provided, comprising the steps of providing an investor intermediary computer having a digital data store, inputting data into the digital data store representing the bid specifications provided for the investment of funds excess to current requirements including the date and time that bids will be accepted, and providing a digital input/output electronic two-way communications link allowing communication between the investor intermediary computer and a plurality of investment provider computers by means of a web browser. The bid specifications provided for the investment of funds is transmitted to or accessed by the plurality of investment provider computers, and bids are transmitted from respective investment provider computers representing bids to make a yield-based payment for the use of the funds. The step of receiving bids transmitted from respective investment provider computers includes the step of blocking subsequent bids in response to the same investment from the same investment provider computer. The bidders are prevented from seeing the bid of any other bidder, and from changing a bid once the bid is transmitted from the respective investment provider computer. The highest yielding bid for the investment that is in compliance with the bid specifications of the investment being sought received from the investment provider computers is determined, and the bid of the highest yielding bid for the investment that is in compliance with the bid specifications of the investment being sought received is accepted.

According to yet another embodiment of the invention, the yield-based payment comprises an investment having a fixed rate of interest or a floating rate based on a predetermined index as specified in the bidding documents.

According to yet another embodiment of the invention, the yield-based payment comprises a guaranteed investment contract or investments purchased for a yield restricted defeasance escrow.

According to yet another embodiment of the invention, an electronic method for obtaining bids for investments, comprises the steps of providing an investor intermediary computer having a digital data store, inputting data into the digital data store representing the bid specifications of the investment, and providing a digital input/output electronic two-way communications link allowing communication between the investor intermediary computer and a plurality of investment provider computers by means of an electronic two-way communications link. The bid specifications for the investment are transmitted to the plurality of investment provider computers, and the received bids are transmitted from investment provider computers to make a yield-based or fixed price-based investment based on the bid specifications provided for the investment.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 is a schematic diagram showing the components utilized in the practice of the method according to the invention; and

FIG. 2 is a flow diagram of a preferred embodiment of the method according to the invention.

### DESCRIPTION OF THE PREFERRED EMBODIMENTS AND BEST MODE

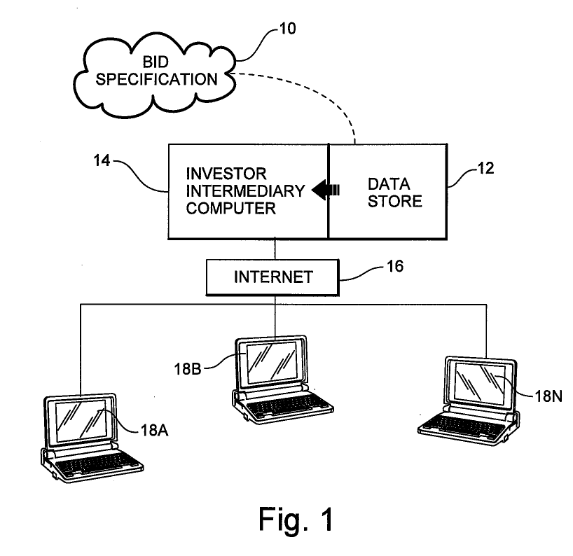

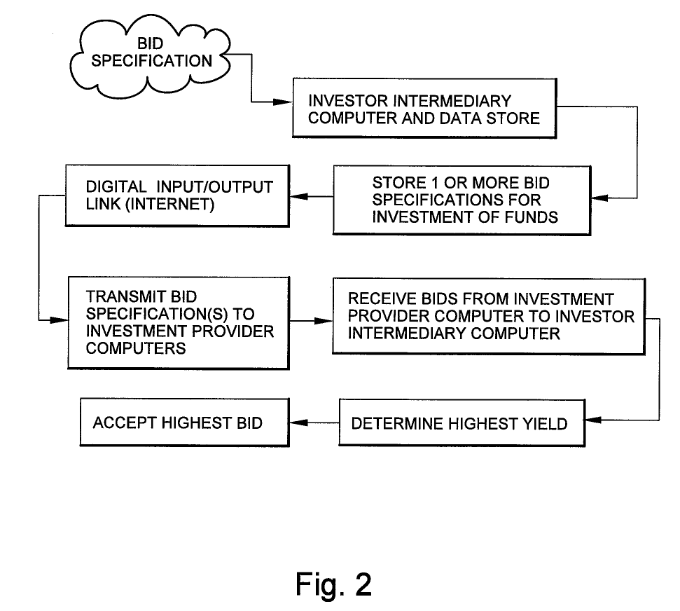

Referring now specifically to the drawings, the method according to the invention disclosed herein takes place within the environment of computers, digital data stores and electronic two-way communications by means of, for example, the internet and the use of internet or web browsers. As shown in FIGS. 1 and 2, bid specifications 10, which may be made in any manner, are transmitted to the data store 12 of an investor intermediary computer 14. An “investor intermediary” refers to any intermediary who acts to facilitate communications between an entity, for example, a governmental, private or pubic entity, and one or more investors who are willing to make an investment.

Based on a predetermined schedule, the bid specifications 10 stored in the data store 12 are posted on a website by the investor intermediary computer 14 and are available over the internet 16 for being reviewed by one or more investment providers via computers 18A, 18B 18N. Investment providers may be any entity acceptable to and approved by the investor willing to pay for the right to use the funds that are the subject of the bid specifications 10 of the investment being sought according to the bid specifications of the investment being sought. Bids may then be communicated via the internet or other electronic two-way communications link back to the investor intermediary computer 14. The received bids are transmitted from investment provider computers to make a yield-based or fixed price-based investment based on the bid specifications provided for the investment being sought, as shown in FIG. 2.

According to the bid specifications of the investment being sought, bids transmitted from the investment provider computers 18A-18N may result in subsequent bids being blocked in response to the same investment being bid on from the same investment provider computer. Similarly, bidders may be prevented from seeing the bid of any other bidder or changing a bid once the bid is transmitted from the respective investment provider computer 18A-18N back to the investor intermediary computer 14.

An electronic method for obtaining bids for investments is described above. Various details of the invention may be changed without departing from the scope of the invention. Furthermore, the foregoing description of the preferred embodiment of the invention and best mode for practicing the invention are provided for the purpose of illustration only and not for the purpose of limitation, the invention being defined by the claims.

We claim:

1. An electronic method for maximizing the rate of return for funds in excess to current requirements, comprising the steps of:
(a) providing an investor intermediary computer having a digital data store;
(b) inputting data into the digital data store representing one or more bid specifications for the investment of funds excess to current requirements for a specified time period:
(c) providing a digital input/output electronic communications link allowing communication between the investor intermediary computer and a plurality of investment provider computers by means of a web browser;
(d) transmitting the one or more bid specifications for the investment of funds to the plurality of investment provider computers;
(e) receiving bids transmitted from respective investment provider computers representing bid specifications to make a yield-based payment for the use of the funds;
(f) determining the highest yield received from the investment provider computers; and
(g) accepting bid of the highest yield received.

2. A method according to claim 1, wherein the step of receiving bids transmitted from respective investment provider computers includes the step of blocking subsequent bids in response to the same investment from the same investment provider computer.

3. A method according to claim 1, and including the step of preventing bidders from seeing the bid of any other bidder.

4. A method according to claim 1, and including the step of preventing bidders from changing a bid once the bid is transmitted from the respective investment provider computer.

5. An electronic method for maximizing the rate of return for funds in excess of current requirements, comprising the steps of:
(a) providing an investor intermediary computer having a digital data store;
(b) inputting data into the digital data store representing the bid specifications of the investment being sought;
(c) providing a digital input/output electronic two-way communications link allowing communication between the investor intermediary computer and a plurality of investment provider computers by means of a web browser or other electronic two-way communications link;
(d) transmitting the bid specifications of the investment being sought for the investment of funds to the plurality of investment provider computers;
(e) receiving bids transmitted from respective investment provider computers representing bids to make a yield-based payment for the use of the funds, wherein the step of receiving bids transmitted from respective investment provider computers includes the step of blocking subsequent bids in response to the same investment from the same investment provider computer;
(f) preventing bidders from seeing the bid of any other bidder;
(g) preventing bidders from changing a bid once the bid is transmitted from the respective investment provider computer;
(h) determining the highest yielding bid for the investment that is in compliance with the bid specifications of the investment being sought received from the investment provider computers; and
(i) accepting bid of the highest yielding bid for the investment that is in compliance with the bid specifications of the investment being sought received.

6. A method according to claim 5, wherein the yield-based payment comprises an investment having a fixed rate of interest or a floating rate based on a predetermined index as specified in the bid specifications of the investment being sought.

7. A method according to claim 57 wherein the investment is comprised of a guaranteed investment contract or investment purchased for a yield restricted defeasance escrow.

8. An electronic method for obtaining bids for investments, comprising the steps of:
(a) providing an investor intermediary computer having a digital data store;
(b) inputting data into the digital data store representing the bid specifications of the investment:
(c) providing a digital input/output electronic two-way communications link allowing communication between the investor intermediary computer and a plurality of investment provider computers by means of a web browser or other electronic two-way communications link;
(d) transmitting the bid specifications for the investment to the plurality of investment provider computers; and
(e) receiving bids transmitted from investment provider computers to make a yield-based or fixed price-based investment based on the bid specifications provided for the investment.

9. An electronic method for maximizing the rate of return for funds in excess of current requirements, comprising the steps of:
(a) providing an investor intermediary computer having a digital data store;
(b) inputting data into the digital data store representing the bid specifications of the investment being sought;
(c) providing a digital input/output electronic two-way communications link allowing communication between the investor intermediary computer and a plurality of investment provider computers by means of a web browser or other electronic two-way communications link;
(d) transmitting the bid specifications of the GIC or investments purchased for a yield restricted defeasance escrow being sought to the plurality of investment provider computers;
(e) receiving the bids for investments from the investment providers for a yield-based or fixed price-based investment based on the bid specifications provided for the investment;
(f) determining the highest yielding bid for the investment that is in compliance with the bid specifications of the investment being sought received from the investment provider computers; and
(g) accepting bid of the highest yielding bid for the investment that is in compliance with the bid specifications of the investment being sought received.
